(19) United States
(12) Patent Application Publication
(10) Pub. No.: US 2009/0080170 A1
(43) Pub. Date: Mar. 26, 2009

(54) Electronic carrier board

(75) Inventor: Wen-Ming Tseng, Taipei (TW)

Correspondence Address: RABIN & Berdo, PC, 1101 14TH STREET, NW, SUITE 500, WASHINGTON, DC, 20005, US

(73) Assignees: MICRO-STAR INT'L CO., LTD, Taipei (TW); MSI Electronic (Kun Shan) Co., Ltd, Kunshan City (CN)

(21) Appl. No.: 11/979,498

(22) Filed: Nov. 5, 2007

(30) Foreign Application Priority Data
Sep. 21, 2007 (TW) 096216002

(51) Int. Cl. H01R 9/00

(52) U.S. Cl. 361/772

(57) ABSTRACT

An electronic carrier board includes a plurality of round pads and a plurality of solder layers formed on the round pads respectively. The design of the round pads ensures the solder layers covering the pads completely, and neighboring sides of the two solder layers are lower than opposite sides, such that electronic element can be stably fixed on the two solder layers to prevent the tombstone of the electronic element.

### CROSS-REFERENCE TO RELATED APPLICATIONS

This non-provisional application claims priority under 35 U.S.C. § 119(a) on Patent Application No(s). 096216002 filed in Taiwan, R.O.C. on Sep. 21, 2007, the entire contents of which are hereby incorporated by reference.

### BACKGROUND OF THE INVENTION

1. Field of Invention

The present invention relates to an electronic carrier board. More particularly, the present invention relates to an electronic carrier board that allows a plurality of electronic elements to be electrically connected to pads through solder layers.

2. Related Art

With the progress of integrated circuit (IC) technology, the design and fabrication of electronic elements are in the trend of miniaturization. Thus, current electronic products are provided with electronic circuits of higher integrity, such that the electronic products have more complete and powerful functions.

Based on the requirements on electrical property and performance, a plurality of passive electronic elements, such as capacitors, resistors, inductors, etc. are disposed on a circuit carrier board, so as to maintain the stability of the electrical quality of the electronic products. Currently, surface mount technology (SMT) is a mainstream technology in the electronic mount, which achieves disposing a plurality of pads on the circuit carrier board with the minimum area. Solder paste is filled on the pads to serve as a conductive material between the circuit carrier board and the electronic elements.

The SMT is closely related to the pad structure of the circuit carrier board. Therefore, if the pad structure is not well designed, e.g. usually designed to be a rectangular structure, the problems that the solder paste cannot cover the pads completely since the solder paste can only be melted in the central portion of the pads during a reflow process, or the solder paste overflows often occur. As a result, when the electronic elements are disposed on the pads, the phenomena of poor bonding strength, position offset, tombstone will be happened, which greatly reduces the electrical quality of the circuit carrier board.

Furthermore, since the conventional pads are mostly made of a metal material such as copper or copper alloy, the solder paste is gathered in the central portion of the pads after reflow, and cannot cover the pads completely. Thus, the exposed pads are oxidized to generate copper oxide. The formed copper oxide obstructs the flow of the solder paste, and also increases the probability of the short circuit of the electronic element.

### SUMMARY OF THE INVENTION

In view of the above problem, the present invention provides an electronic carrier board, so as to solve the problem of low electrical quality of circuit carrier board resulting from the phenomena of poor bonding strength, position offset, tombstone of the electronic elements when being soldered on the substrate in the prior art.

The electronic carrier board of the present invention includes a substrate, a plurality of round pads, a solder mask layer, a plurality of solder layers, and a plurality of electronic elements. The round pads are disposed on the substrate. The solder mask layer is covered on the substrate and has a plurality of openings at positions corresponding to the round pads, so as to expose the round pads. The solder layers are formed on the exposed round pads and cover the pads completely. Neighboring sides of two solder layers are lower than opposite sides of the two solder layers, such that the electronic elements are stably disposed above the solder layers and electrically connected to the pads.

The advantage of the present invention lies in that, the design of round pad can save area of the substrate, so as to accommodate more quantity of the electronic elements on the same unit area of the substrate. Also, the design of round pads facilitates the circuit layout, and solves the problem that the edges of the conventional rectangular pads cannot easily retain solder paste.

Furthermore, the solder layer with two sides of different height allows the electronic elements to be stably soldered thereon, thus solving the problem of poor electrical quality of the electronic carrier board resulting from the phenomena of tombstone or offset of the electronic elements.

Further scope of applicability of the present invention will become apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from this detailed description.

### BRIEF DESCRIPTION OF THE DRAWINGS

The present invention will become more fully understood from the detailed description given herein below for illustration only, and thus are not limitative of the present invention, and wherein:

FIG. 1 is a partial perspective view of a first embodiment of the present invention;

FIG. 2 is a partial schematic plan view of the first embodiment of the present invention;

FIG. 3 is a schematic cross-sectional view of the first embodiment of the present invention; and

FIG. 4 is a partial perspective view of a second embodiment of the present invention.

### DETAILED DESCRIPTION OF THE INVENTION

The electronic carrier board provided by the present invention can be a carrier board with circuit pattern, such as a package substrate for packaging, a circuit board, or a printed circuit board, but the present invention is not limited hereby. In the following detailed description of the present invention, the printed circuit board is taken as the preferred embodiment of the present invention. However, the accompanying drawings are provided merely for reference and illustration, and do not intend to limit the scope of the present invention.

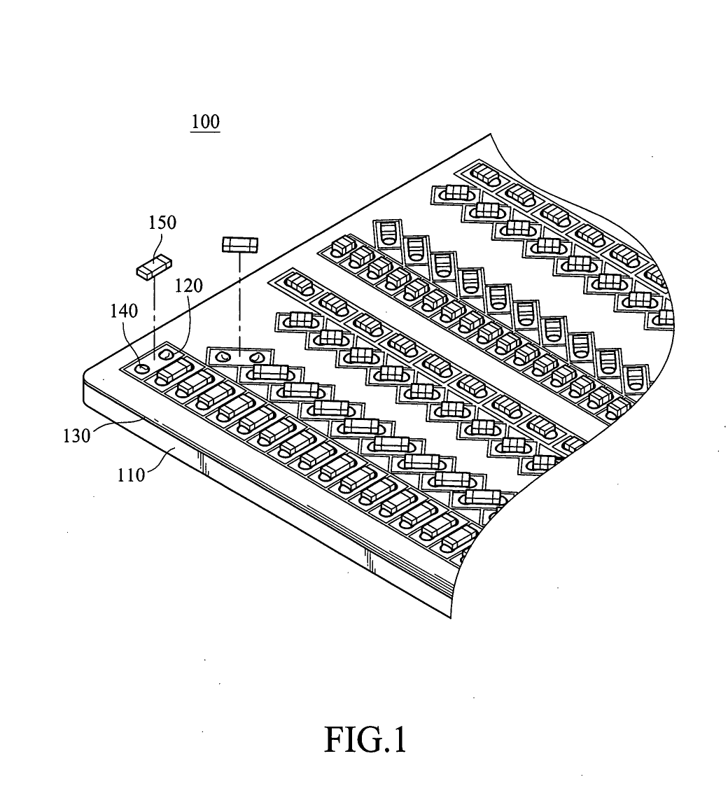

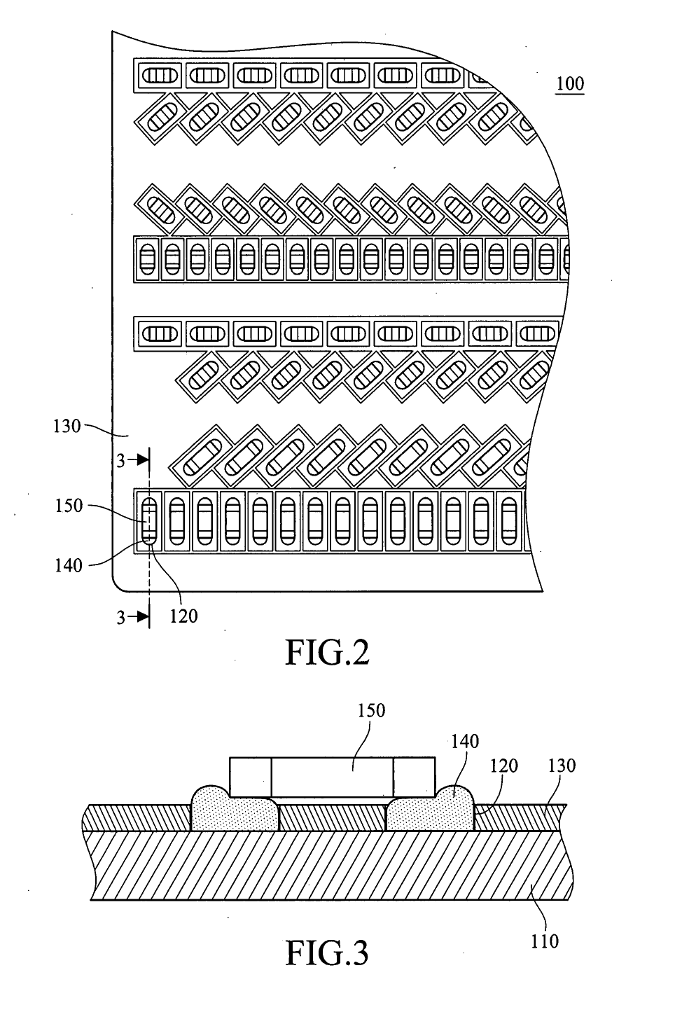

FIGS. 1 to 3 are schematic views of a first embodiment of the present invention. An electronic carrier board 100 disclosed in the present invention includes a substrate 110, a plurality of round pads 120, a solder mask layer 130, a plurality of solder layers 140, and a plurality of electronic elements 150. The substrate 110 can be an insulating plate or an insulating plate with circuit layers (not shown) stacked in-between. The round pads 120 are made of a metal material of high conductivity, for example, copper or copper alloy, which is well known to those skilled in the art, so will not be described herein again.

The round pads 120 are designed to be circular shaped, and are arranged in an array on the substrate 110. The round pads 120 are separated by a distance of 0.8 mm to 0.85 mm, so that more quantity of the round pads 120 may be accommodated on the same unit area of the substrate 110. The solder mask layer 130 is covered on the substrate 110, and has a plurality of openings at positions corresponding to the round pads 120, so as to expose the round pads 120 when the solder mask layer 130 is covered on the substrate 110.

The solder paste is filled on the exposed round pads 120 by means of printing, so as to form the solder layers 140. However, those skilled in the art would appreciate that the solder paste may also be filled onto the round pads through coating, scraping printing, spraying, and so on, which is not limited to the embodiments of the present invention. In the course of forming the solder layers 140, height of neighboring sides of two neighboring solder layers 120 is controlled to be slightly lower than height of opposite sides of the two solder layers 120.

The plurality of electronic elements 150 are, for example, passive electronic elements such as capacitors, resistor, and inductors, and are separately disposed on the solder layers 140 in pairs by the arrangement of a machine. Then, a reflow step is performed to heat the solder layers 140, such that the solder layers 140 are melted and flow in the reflow step to fill up the openings of the solder mask layer 130 and to cover the round pad 120 completely, thereby preventing the problem that the edges of the pads cannot retain the solder uniformly and are easy to be oxidized since the solder paste cannot cover the pads completely due to the shape of the conventional rectangular pads.

In addition, as the two sides of the solder layers 140 have different height, the electronic elements 150 can be stably soldered on the solder layers 140 in pairs. The electronic elements 150 are electrically connected to the pads 120 via the solder layers 140, so as to prevent the phenomena of position offset or tombstone of the electronic elements 150 occurring in the reflow process to cause the contact short circuit of the electronic elements 150.

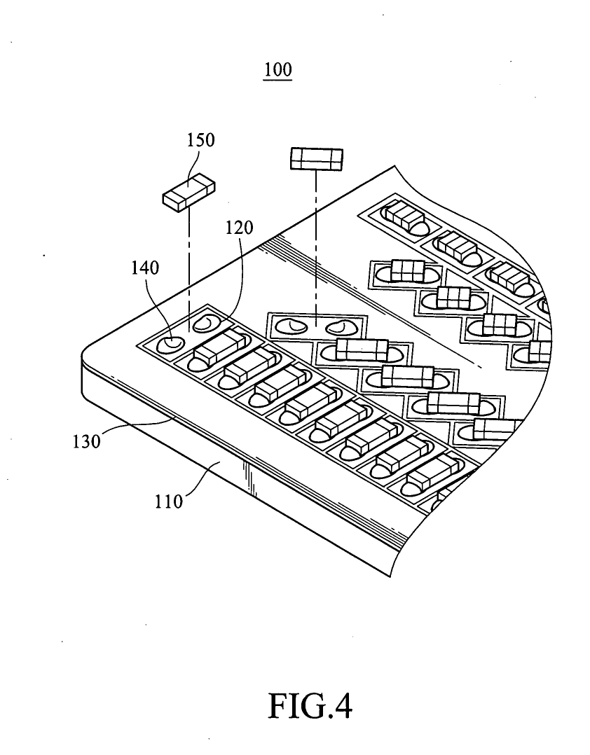

FIG. 4 is a perspective view of a second embodiment of the present invention. Please refer to FIG. 4, the shape of the plurality of the round pads 120 disclosed in the present invention can be further designed to be circular-shaped in the first embodiment and elliptical-shaped in the second embodiment according to the layouts on the electronic carrier boards of different types.

In addition, since the area sizes of the circular and the elliptical pads 120 are different, the amounts of solder retained on the round pads 120 of different types are also different. Therefore, the pads 120 on the substrate 110 of the present invention are designed to have a suitable shape according to the electronic elements 150 of different types, so as to accurately control the amount of the solder paste for the electronic carrier board 110, and to prevent the overflow or lack of the solder paste, thus avoiding the short circuit of the electronic elements 150 or the poor bonding strength.

In the electronic carrier board disclosed in the present invention, the design of the round pads greatly reduces the occupied substrate area, such that the electrical layout on the substrate is more convenient, and more quantity of the electronic elements can be accommodated on the substrate, so as to improve the electrical quality of the electronic carrier board. After the reflow step, the solder layer are melted and cover the round pads completely, thereby solving the problem that the edges of the conventional rectangular pad cannot easily retain the solder and are easy to be oxidized.

The height of the neighboring sides of the solder layers in pairs of the present invention is lower than that of the opposite sides of the solder layers in pairs, the electronic elements can be stably soldered on the two solder layers while maintaining good electrical connection relationship with the pads, such that the electrical quality and yield of the electronic carrier boards are greatly improved.

The invention being thus described, it will be obvious that the same may be varied in many ways. Such variations are not to be regarded as a departure from the spirit and scope of the invention, and all such modifications as would be obvious to one skilled in the art are intended to be included within the scope of the following claims.

What is claimed is:

1. An electronic carrier board, comprising:
a substrate;
a plurality of round pads, disposed on the substrate;
a solder mask layer, covered on the substrate and having a plurality of openings at positions corresponding to the round pads, so as to expose the round pads;
a plurality of solder layers, respectively disposed on the exposed round pads, wherein neighboring sides of two solder layers are lower than opposite sides; and
a plurality of electronic elements, respectively disposed on the solder layers and electrically connected to the pads through the solder layers.

2. The electronic carrier board as claimed in claim 1, wherein the round pads are arranged in an array on the substrate.

3. The electronic carrier board as claimed in claim 1, wherein the round pads are circular or elliptical shaped.

4. A round pad for an electronic carrier board, wherein a solder layer is disposed on the respective round pads, and neighboring sides of two solder layers are lower than opposite sides.

5. The round pad as claimed in claim 4, wherein the round pads are arranged in an array on the substrate.

6. The round pad as claimed in claim 4, wherein the round pads are circular or elliptical shaped.
